(19) United States
(12) Patent Application Publication
(10) Pub. No.: US 2012/0034506 A1
(43) Pub. Date: Feb. 9, 2012

(54) REVERSE USE BATTERY PACK DESIGN

(76) Inventors: Chih-Kai Hu, Taoyuan County (TW); Chien-Hung Chen, Taoyuan County (TW); Ta-Wei Liu, Taoyuan County (TW)

(21) Appl. No.: 12/954,607

(22) Filed: Nov. 24, 2010

(30) Foreign Application Priority Data
Aug. 6, 2010 (TW) 099126279

(51) Int. Cl. H01M 2/10

(52) U.S. Cl. 429/100

(57) ABSTRACT

A battery pack of a handheld device has two coupling sections configured at a side surface in the face of a battery slot of the handheld device, where the coupling sections correspond to a coupling structure of the battery slot. As the battery pack is installed in the battery slot, the coupling sections engage with the coupling structure respectively for keeping the battery pack from detaching out of the battery slot. The battery pack may also have an upturned position to be installed in a second type of battery slot of another handheld device, where the coupling sections also correspond to and engage with a coupling structure of the second battery slot and keep the battery pack from detaching out of the second battery slot.

### BACKGROUND OF THE INVENTION

1. Field of the Invention

The subject application relates to a battery pack, and more particularly, to a battery pack capable of being reversely used for being installed in battery slots of two handheld devices.

2. Description of the Prior Art

Conventional handheld devices are commonly equipped with replaceable rechargeable batteries. Since each handheld device has a unique battery slot design for its battery, the battery slot of one handheld device needs to be matched with the battery in its shape and corresponding structures. In other words, a conventional battery pack can only be applied for one corresponding battery slot of a handheld device, which accordingly, causes immense increase of cost of design and manufacturing of the batteries.

### SUMMARY OF THE INVENTION

The subject application provides a battery pack, for being installed in a first battery slot of a first handheld device or for being rotated along a first direction to be installed in a second battery slot of a second handheld device and for providing power for the first handheld device or the second handheld device. The first battery slot has a first coupling section and a second coupling section and the second battery slot has a fifth coupling section and a sixth coupling section. Each of the first coupling section and the sixth coupling section has a first contour, and each of the second coupling section and the fifth coupling section has a second contour. The battery pack includes a side surface. A third coupling section is disposed on the side surface and has a third contour corresponding to the first contour and is utilized for engaging with the first coupling section or the sixth coupling section along the first direction so as to restrain movement of the battery pack along a second direction in the first battery slot or in the second battery slot. The battery pack also include a fourth coupling section disposed on the side surface and having a fourth contour corresponding to the second contour and utilized for engaging with the second coupling section or the fifth coupling section along the first direction so as to restrain movement of the battery pack along the second direction in the first battery slot or in the second battery slot. The third contour is different from the second contour such that the third coupling section is blocked by the second coupling section along the first direction and can not engage with the second coupling section. The first battery slot has a mirror mapping contour corresponding to the second battery slot with regard to the first direction.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a battery pack and a battery slot of a handheld device according to a first embodiment of the present invention.

FIG. 2 and FIG. 3 are partial diagrams in another view of the battery slot of the battery pack according to the first embodiment.

FIG. 4 is a schematic diagram of a battery pack and a battery slot of a handheld device according to a second embodiment of the present invention.

FIG. 5 and FIG. 6 are partial diagrams in another view of the battery slot of the battery pack according to the second embodiment.

FIG. 7 is a schematic diagram of a battery pack and a battery slot of a handheld device according to a third embodiment of the present invention.

FIG. 8 and FIG. 9 are partial diagrams in another view of the battery slot of the battery pack according to the third embodiment.

### DETAILED DESCRIPTION

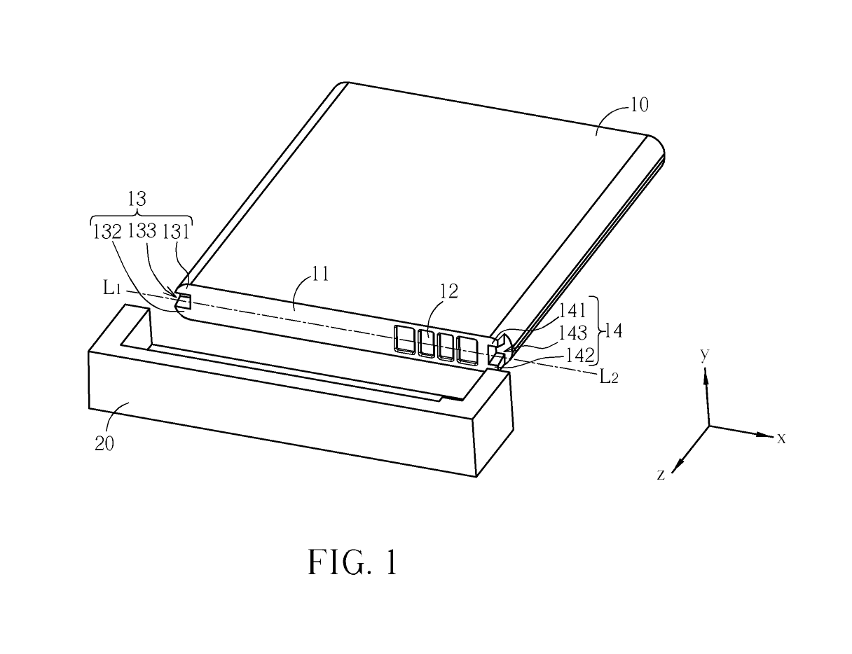

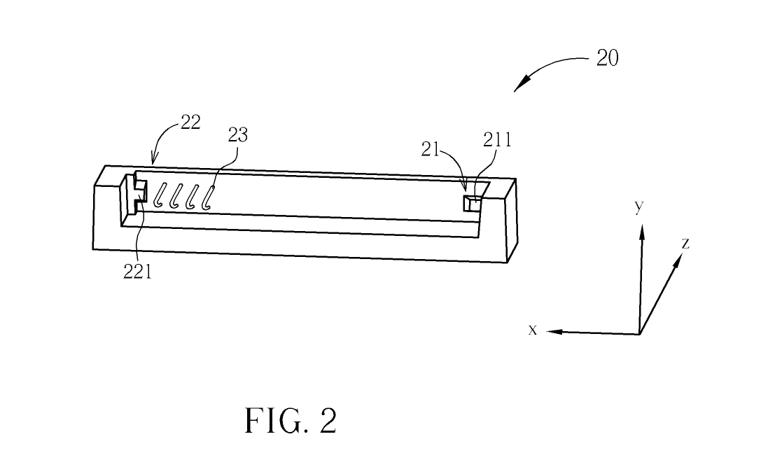

Please refer to FIG. 1 and FIG. 2. FIG. 1 is a schematic diagram of a battery pack 10 and a battery slot 20 of a handheld device according to a first embodiment of the present invention. FIG. 2 is a partial diagram in another view of the battery slot 20 of the battery pack 10 according to the first embodiment. The handheld device can be, but not limited to, a foldable type, a clamshell type, a bar type, a slide type, a tablet type, or other types of cell phone, smart phone, personal digital assistant, navigator device, notebook computer, tablet computer, mobile processing device, mobile communications device, and so on. For simplicity, the drawings of the subject application only show the partial diagrams related to the battery slot 20 and the battery pack 10 of the handheld device, and the other parts of the handheld device will be omitted herein.

The battery pack 10 is installed in the battery slot 20 of the handheld device in a detachable and replaceable manner for providing power for the handheld device. The battery pack 10 can be, but not limited to, a chargeable battery such as a Ni-MH, a Li-ion battery, and so on. The battery pack 10 is installed in the battery slot 20 along a direction of z-axis as shown in FIG. 1. The battery pack 10 has a side surface 11, where a plurality of electrical contacts 12 are disposed, along an installing direction of the battery pack 10, and a plurality of pogo pins 23 are disposed on the battery slot 20 at a corresponding position. When the battery pack 10 is installed in the battery slot 20 along the direction of z-axis, the electrical contacts 12 couple to the pogo pins 23 respectively so as to be electrically connected and provide power.

Since the battery pack 10 varies depending on different handheld devices some engaging structure between the battery pack 10 and the battery slot 20 allows the battery pack 10 to be installed in the handheld device only in a specific manner. Furthermore, the engaging structure also prevents the battery pack 10 from dropping out along a direction of y-axis when the battery pack 10 is installed in the battery slot 20.

Please refer to FIG. 2. The battery slot 20 includes a first coupling section 21 and a second coupling section 22 located respectively on both sides of a surface that is contacted by the side surface 11 of the battery pack 10. The battery pack 10 includes a corresponding third coupling section 13 and a corresponding fourth coupling section 14, located on the side surface 11 of the battery pack 10 respectively. In the first embodiment, the first coupling section 21 includes a protrusion 211 having a first contour (a rectangular contour, but not limited to, is illustrated in the first embodiment, the contour can also be polygon-shaped or arc-shaped), and the corresponding third coupling section 13 of the battery pack 10 includes a first arm 131, a second arm 132, and a recess 133. The recess 133 has a third contour corresponding to the first contour, and the first arm 131, the recess 133, and the second arm 132 are arranged in sequence along the direction of y-axis. In other words, the recess 133 is formed between the first arm 131 and the second arm 132. Due to the third contour of the third coupling section 13, when the battery pack 10 is installed in the battery slot 20 along the direction of z-axis, the protrusion 211 of the first coupling section 21 reaches into the recess 133 such that the first coupling section 21 engages with the third coupling section 13. Meanwhile, the first arm 131 and the second arm 132 of the third coupling section 13 abut against both sides of the protrusion 211 of the first coupling section 21 along the direction of y-axis so as to restrain the movement of the battery pack 10 along the direction of y-axis with regard to the battery slot 20. In other words, the battery pack 10 will not drop out of the battery slot 20 along the direction of y-axis.

Similarly, in the first embodiment, the second coupling section 22 includes a protrusion 221, which has a second contour (a T-shaped contour, but not limited to, is illustrated in the first embodiment, the contour can also be polygon-shaped or arc-shaped), and the corresponding fourth coupling section 14 of the battery pack 10 includes a first arm 141, a second arm 142, and a recess 143. The recess 143 has a fourth contour corresponding to the second contour, and the first arm 141, the recess 143, and the second arm 142 are arranged in sequence along the direction of y-axis. In other words, the recess 143 is formed between the first arm 141 and the second arm 142. Due to the fourth contour of the fourth coupling section 14, when the battery pack 10 is installed in the battery slot 20 along the direction of z-axis, the protrusion 221 of the second coupling section 22 reaches into the recess 143 such that the second coupling section 22 engages with the fourth coupling section 14. Meanwhile, the first arm 141 and the second arm 142 of the fourth coupling section 14 abut against both sides of the protrusion 221 of the second coupling section 22 along the direction of y-axis so as to restrain the movement of the battery pack 10 along the direction of y-axis with regard to the battery slot 20. In other words, the battery pack 10 will not drop out of the battery slot 20 along the direction of y-axis.

In the aforesaid embodiment, in order to avoid that the battery pack 10 is falsely installed in the battery slot 20 with reverse side (that is the battery pack 10 is rotated relative to the z-axis) such that the electrical contacts 12 of the battery pack 10 cannot correctly couple to the pogo pins 23 of the battery slot 20, in this embodiment of the present invention, at least one coupling section of the coupling section 13, 14 of the battery pack 10 can engage with the corresponding coupling section of the battery slot 20 only, and it cannot engage with the other coupling section of the battery slot 20. Accordingly, when the battery pack 10 is assembled without obeying the aforesaid corresponding manner, the assembly will fail whereby it can avoid mis-plugging of the battery pack 10. To achieve such purpose, the first contour of the first coupling section 21 (as well as the corresponding third contour of the third coupling section 13) and the second contour of the second coupling section 22 (as well as the corresponding fourth contour of the fourth coupling section 14) are different in shapes, such that the third contour of the third coupling section 13, for example, the rectangular-shaped contour of the recess 133 in this embodiment, is different from the second contour of the second coupling section 22, for example, the T-shaped contour of the protrusion 221 in this embodiment. By doing so, if the battery pack 10 is to be installed with reverse side, with the third coupling section 13 aiming at the second coupling section 22 and the fourth coupling section 14 aiming at the first coupling section 21, the protrusion 221 is not allowed to reach into the recess 133 and the battery pack 10 will not be installed therein properly. It should be also noticed that the aforesaid recess 133 and recess 143 are two recesses arranged oppositely at the sides of the battery pack 10 and having asymmetric contours.

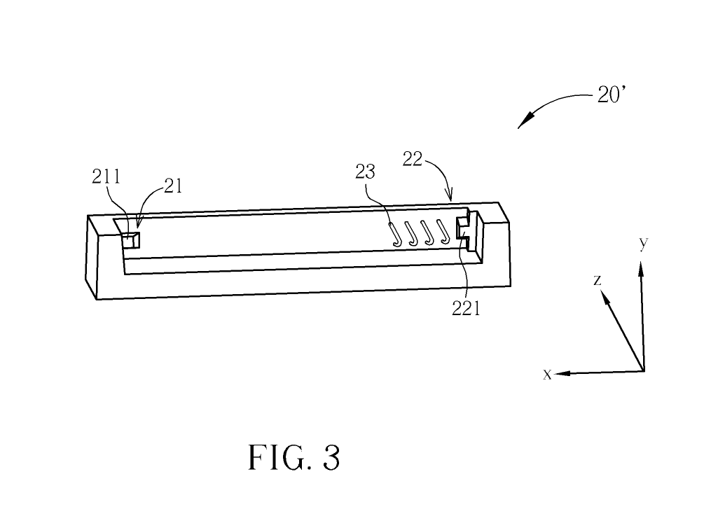

Since the electrical contacts 12 of the battery pack 10 are located at the right portion of the side surface 11 in the first embodiment as shown in FIG. 1, a handheld device having the battery slot 20 as shown in FIG. 2, whose pogo pins 23 are located at the left portion, is ready for the battery pack 10 to be installed in a manner as shown in FIG. 1. For another battery slot with the pogo pins being located at the right portion, such as the battery slot 20′ of another handheld device as shown in FIG. 3, the battery pack 10 of the present invention of the first embodiment can be installed in the battery slot 20′ in a reverse manner by rotating along the direction of z-axis, wherein the coupling sections of the battery pack 10 also correspond to the coupling sections of the battery slots 20′, too. The reversed battery pack 10 can be securely installed in the battery slot 20′ and will not drop out along the direction of y-axis in the battery slot 20′. The battery pack 10 described in the first embodiment of the present invention effectively solves the problem that a conventional battery pack can only be applied for one handheld device. The battery pack 10 can be installed in a second handheld device after rotation. Not only the types of the battery packs and cost for manufacturing the battery packs can be reduced but also the development of new devices is enhanced.

Additionally, in the first embodiment, the third coupling section 13 (as well as the corresponding first coupling section 21 of the battery slot 20) and the fourth coupling section 14 (as well as the corresponding second coupling section 22 of the battery slot 20) preferably have symmetric structures with regard to a central axis L₁L₂ located on the side surface 11 of the battery pack 10. In this embodiment, the direction of the central axis L₁L₂ is the same direction as the x-axis, and the x-axis, the aforesaid y-axis and z-axis are perpendicular to one another.

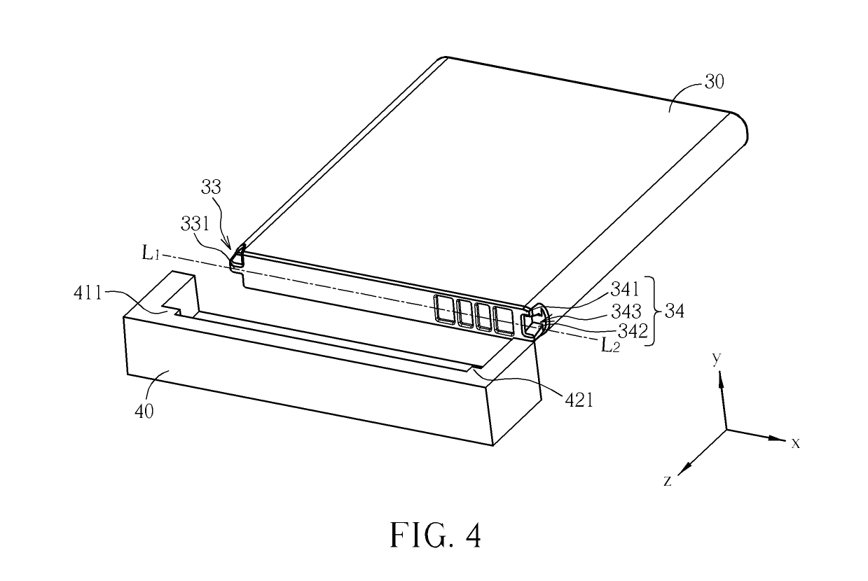

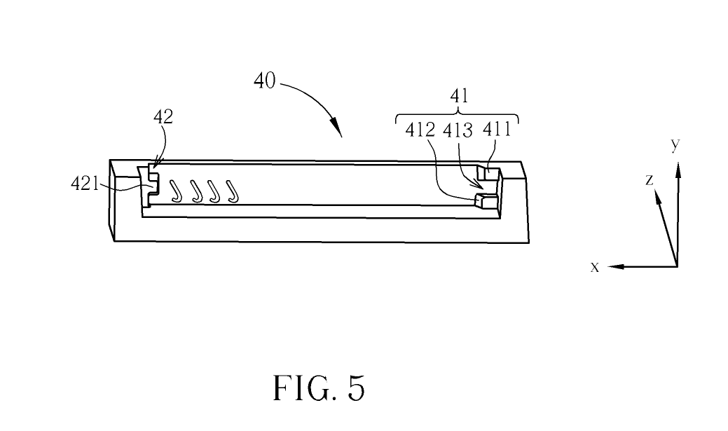

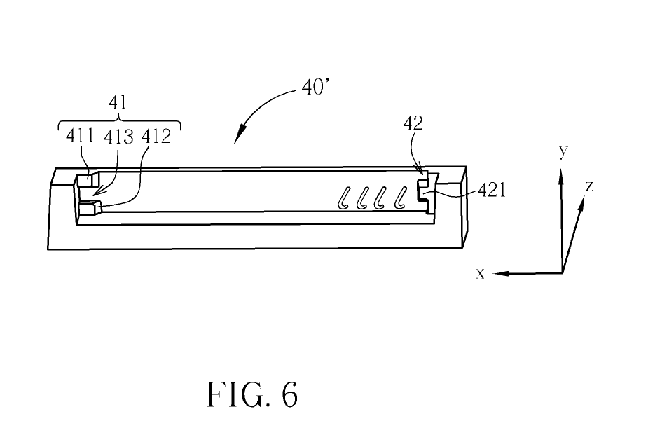

Please refer to FIG. 4 and FIG. 5. FIG. 4 is a schematic diagram of a battery pack 30 and a battery slot 40 of a handheld device according to a second embodiment of the present invention. FIG. 5 is a partial diagram in another view of the battery slot 40 of the battery pack 30 according to the second embodiment. In the second embodiment of the present invention, a third coupling section 33 of the battery pack 30 includes a protrusion 331. A fourth coupling section 34, similar to the fourth coupling section 14 in the first embodiment, includes a first arm 341, a recess 343, and a second arm 342 arranged along a direction of y-axis. A first coupling section 41 of the battery slot 40 includes a third arm 411, a recess 413, and a fourth arm 412 arranged along the direction of y-axis. A second coupling section 42 includes a protrusion 421 utilized for engaging with the recess 343 of the fourth coupling section 34. Since the third coupling section and the fourth coupling section 34 of the battery pack 30 respectively engage with the first coupling section 41 and the second coupling section 42 of the battery slot 40 in the second embodiment, the battery pack 30 can be installed in the battery slot 40 and will not drop off. Furthermore, the third coupling section 33 and the fourth coupling section 34 are not allowed to engage with the second coupling section 42 and the first coupling section 41 of the battery slot 40 respectively after rotation. Accordingly, it can prevent the possibility that the battery pack 30 is falsely installed in the battery slot 40. Installation and engaging relation between the battery pack 30 and the battery slot 40 in the second embodiment are similar to those mentioned in the first embodiment. Additionally, the battery pack 30 can be reversely used to be installed in a battery slot of a second handheld device after rotation. Accordingly, it can enhance convenience of the battery pack 30 in practical application. For another battery slot with the pogo pins being located at the right portion, such as a battery slot 40′ of another handheld device as shown in FIG. 6, the battery pack 30 in the second embodiment can be installed in the battery slot 40′ in a reverse manner after rotating along the direction of z-axis, wherein the coupling sections of the battery pack 30 also correspond to the coupling sections of the battery slots 40′, too. The reversed battery pack 30 can be securely installed in the battery slot 40′ and will not drop out along the direction of y-axis in the battery slot 40′.

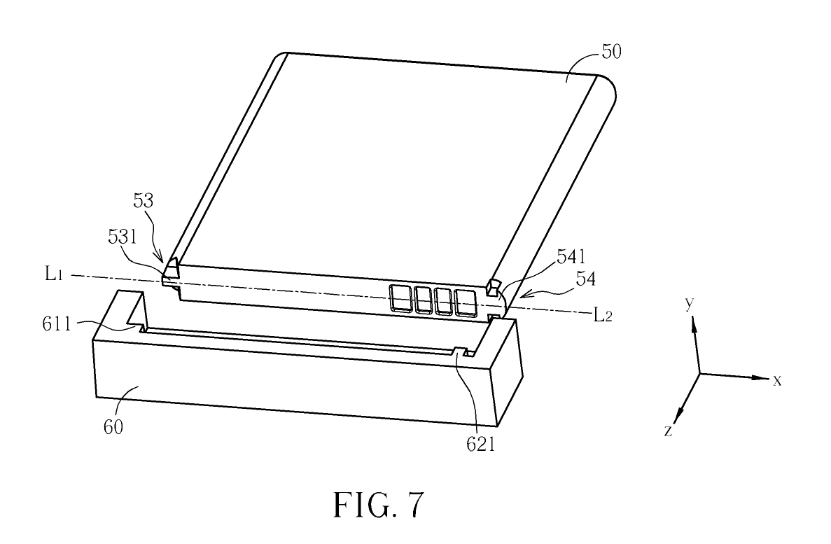

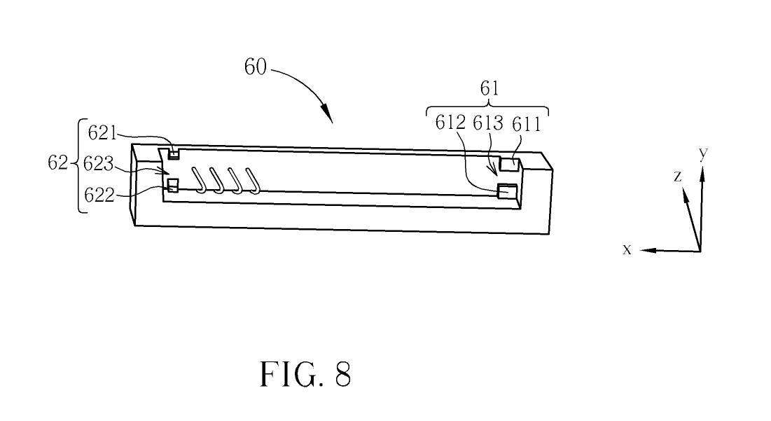

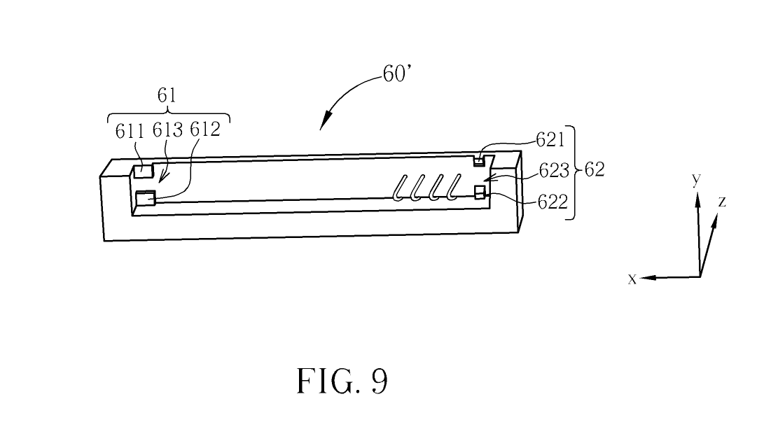

Please refer to FIG. 7 and FIG. 8. FIG. 7 is a schematic diagram of a battery pack 50 and a battery slot 60 of a handheld device according to a third embodiment of the present invention. FIG. 8 is a partial diagram in another view of the battery slot 60 of the battery pack 50 according to the third embodiment. In the third embodiment of the present invention, a third coupling section 53 of the battery pack 50 includes a protrusion 531 and a fourth coupling section 54 includes a protrusion 541. A first coupling section 61 of the battery slot 60 includes a third arm 611, a recess 613, and a fourth arm 612 arranged along a direction of y-axis. A second coupling section 62 includes a third arm 621, a recess 623, and a fourth arm 622 arranged along the direction of y-axis. The first coupling section 61 of the battery slot 60 engages with the third coupling section 53 of the battery pack 50, and the second coupling section 62 engages with the fourth coupling section 54. Accordingly, the battery pack 50 can be installed in the battery slot 60 and will not drop off. Additionally, due to the difference of contours between the third coupling section 53 and the fourth coupling section 54, the battery pack 50 cannot engage with the second coupling section 62 and the first coupling section 61 of the battery slot 60 after rotation. Accordingly, it can prevent the possibility that the battery pack 50 is falsely installed in the battery slot 60. Installation and engaging relation between the battery pack 50 and the battery slot 60 in the third embodiment are similar to those mentioned in the first and second embodiment. Additionally, the battery pack 50 can be reversely used to be installed in the battery slot of second handheld device after rotation. Accordingly, it can enhance convenience of the battery pack 50 in practical application. For another battery slot with the pogo pins being located at the right portion, such as a battery slot 60′ of another handheld device as shown in FIG. 9, the battery pack 50 in the third embodiment can be installed in the battery slot 60′ in a reverse manner after rotating along the direction of z-axis, wherein the coupling sections of the battery pack 50 also correspond to the coupling sections of the battery slots 60′, too. The reversed battery pack 50 can be securely installed in the battery slot 60′ and will not drop out along the direction of y-axis in the battery slot 60′.

The battery pack of the subject application has two coupling sections configured at the side surface in the face of the battery slot of the handheld device, where the coupling sections correspond to coupling structure of the battery slot. As the battery pack is installed in the battery slot, the coupling sections engage with the coupling structure respectively for keeping the battery pack from detaching out of the battery slot. The battery pack may also have an upturned position to be installed in a second type of battery slot of another handheld device, where the coupling sections also correspond to and engage with coupling structure of the second battery slot and keep the battery pack from detaching out of the second battery slot.

Those skilled in the art will readily observe that numerous modifications and alterations of the device and method may be made while retaining the teachings of the invention.

What is claimed is:

1. A battery pack, for being installed in a first battery slot of a first handheld device or for being rotated along a first direction to be installed in a second battery slot of a second handheld device and for providing power for the first handheld device or the second handheld device, the first battery slot having a first coupling section and a second coupling section, the second battery slot having a fifth coupling section and a sixth coupling section, the first coupling section and the sixth coupling section having a first contour respectively, the second coupling section and the fifth coupling section having a second contour respectively, the battery pack comprising:
a side surface;
a third coupling section disposed on the side surface and having a third contour corresponding to the first contour and engaging with the first coupling section or the sixth coupling section along the first direction so as to restrain movement of the battery pack along a second direction in the first battery slot or in the second battery slot; and
a fourth coupling section disposed on the side surface and having a fourth contour corresponding to the second contour and engaging with the second coupling section or the fifth coupling section along the first direction so as to restrain movement of the battery pack along the second direction in the first battery slot or in the second battery slot;
wherein the third contour is different from the second contour such that the third coupling section is blocked by the second coupling section along the first direction and can not engage with the second coupling section, and the first battery slot has a mirror mapping contour corresponding to the second battery slot with regard to the first direction.

2. The battery pack of claim 1, wherein each of the first coupling section and the sixth coupling section comprises a protrusion having the first contour, the third coupling section comprises a first arm, a recess, and a second arm, the recess which is formed between the first arm and the second arm has the third contour, the first arm, the recess, and the second arm are arranged along the second direction, and the protrusion reaches into the recess and the first arm and the second arm abut against both sides of the protrusion when the third coupling section engages with the first coupling section or the sixth coupling section.

3. The battery pack of claim 1, wherein the third coupling section comprises a protrusion having the third contour, each of the first coupling section and the sixth coupling section comprises a third arm, a recess, and a fourth arm, the recess which is formed between the third arm and the fourth arm has the first contour, the third arm, the recess, and the fourth arm are arranged along the second direction, and the protrusion reaches into the recess along the first direction and is clamped by the third arm and the fourth arm when the third coupling section engages with the first coupling section or the sixth coupling section.

4. The battery pack of claim 1, wherein each of the second coupling section and the fifth coupling section comprises a protrusion having the second contour, the fourth coupling section comprises a first arm, a recess, and a second arm, the recess which is formed between the first arm and the second arm has the fourth contour, the first arm, the recess, and the second arm are arranged along the second direction, and the protrusion reaches into the recess and the first arm and the second arm abut against both sides of the protrusion when the fourth coupling section engages with the second coupling section or the fifth coupling section.

5. The battery pack of claim 1, wherein the fourth coupling section comprises a protrusion having the fourth contour, each of the second coupling section and the fifth coupling section comprises a third arm, a recess, and a fourth arm, the recess which is formed between the third arm and the fourth arm has the second contour, the third arm, the recess, and the fourth arm are arranged along the second direction, and the protrusion reaches into the recess along the first direction and is clamped by the third arm and the fourth arm when the fourth coupling section engages with the second coupling section or the fifth coupling section.

6. The battery pack of claim 1, wherein each of the third coupling section and the fourth coupling section comprises a symmetric structure relative to a central axis located on the side surface and perpendicular to the second direction.

7. The battery pack of claim 1, further comprising at least one electrical contact disposed on the side surface, each of the first battery slot and the second battery slot having at least one pogo pin, the electrical contact electrically connected to the pogo pin of the first battery slot or that of the second battery slot to provide the first handheld device or the second handheld device with a power supply when the battery pack is installed in the first battery slot or the second battery slot.

8. The battery pack of claim 1, wherein the first direction and the second direction are perpendicular to each other.
